(19) United States
(12) Patent Application Publication
(10) Pub. No.: US 2026/0098162 A1
(43) Pub. Date: Apr. 9, 2026

(54) LOW TEMPERATURE CURING POWDER COATING COMPOSITION AND ARTICLES FORMED THEREFROM

(71) Applicant: VALSPAR COATINGS (SHANGHAI) CO. LTD., Shanghai (CN)

(72) Inventors: Yongbin CHEN, Shanghai (CN); Jianzhong ZHANG, Shanghai (CN); Wanjun XU, Shanghai (CN)

(21) Appl. No.: 19/110,562

(22) PCT Filed: Sep. 15, 2023
(86) PCT No.: PCT/CN2023/119049

§ 371 Date: Mar. 11, 2025

(30) Foreign Application Priority Data
Sep. 16, 2022 (CN) 202211128678.9

(51) Int. Cl. C09D 5/03; C09D 7/47; C09D 7/65; C09D 167/00

(52) U.S. Cl. CPC C09D 5/033; C09D 7/47; C09D 7/65; C09D 167/00

(57) ABSTRACT

The present application relates to a low temperature curing powder coating composition and articles formed therefrom. The powder coating composition comprises a polyester resin, a triglycidyl isocyanurate (TGIC) curing agent, a β-hydroxyalkylamide (HAA) curing agent and a leveling agent, wherein the leveling agent is a polymeric material in solid form with a melting point below 100° C. and a melt viscosity below 2000 mPa·s, as measured using a Brookfield viscometer at 200° C. The powder coating composition can be cured at a temperature of 140° C. or lower without the addition of any curing accelerator. Moreover, the coating formed by curing the powder coating composition is substantially free of pores.

### TECHNICAL FIELD

The present application relates to a powder coating composition, in particular to a low temperature curing powder coating composition using TGIC and HAA both as a curing agent and articles formed therefrom.

### BACKGROUND

Powder coatings are widely used to provide decorative and/or protective coatings on substrates. Powder coatings have a completely different form from normal coatings in that they exist in the form of a fine powder and do not use solvents. Powder coatings are non-hazardous, highly efficient, resource-saving and environmentally friendly. With the of development, powder coatings have made great progress and their application fields are expanding year by year.

Polyester-based powder coatings are one of the common thermosetting powder coatings in the market, which are generally formulated with a polyester resin as a base material and triglycidyl isocyanurate (TGIC) as a curing agent. Due to good compatibility of this powder coating with existing coating varieties, low cost of raw materials and production, it has a good development prospect. However, the curing temperature of such polyester-type powder coatings is usually high, which inevitably increases energy consumption and reduces production speed of the coatings.

Therefore, under the national policy of energy conservation and emission reduction, there is a need in the market for polyester resin-based powder coating compositions suitable for curing at low temperatures (especially at 140° C. or lower).

### SUMMARY

In one aspect, the present application provides a powder coating composition comprising a polyester resin, a triglycidyl isocyanurate (TGIC) curing agent, a β-hydroxyalkylamide (HAA) curing agent and a leveling agent, wherein the leveling agent is a polymeric material in solid form with a melting point below 100° C. and a melt viscosity below 2000 μmPa·s, as measured using a Brookfield viscometer at 200° C. Preferably, the leveling agent has a melting point in the range of 40 to 100° C.; and/or the leveling agent has a melt viscosity in the range of 800 to 2000 μmPa·s, as measured using a Brookfield viscometer at 200° C.

In a preferred embodiment of the present invention, said polyester resin comprises a mixture of a first polyester resin and a second polyester resin, said first polyester resin having a glass transition temperature of less than 60° C., and said second polyester resin having a melt viscosity as low as 3,000 μmPa·s, as determined using a Brookfield viscometer at 200° C.

On the other hand, the present invention provides an article comprising a substrate; and a coating formed from the powder coating composition according to the first aspect of the present invention applied directly to said substrate. Preferably, said substrate comprises a metal substrate, a wood substrate, a plastic substrate, a glass substrate, a ceramic substrate or a combination thereof.

In the powder coating composition according to the present invention, a polyester resin is used as the base material, both triglycidyl isocyanurate (TGIC) and β-hydroxyalkyl amide (HAA) are combined as a curing agent, and these two curing agents are matched with a leveling agent having specific melting properties, which enables the formed powder coating composition to be suitable for a low-temperature (e.g., at 140° C. or lower) curing, and which can address the problem of pinholes appearing on the surface of coatings especially thickly applied coatings caused by use of a HAA curing agent, so that coatings formed from such powder coating compositions, even coatings having a thickness up to 120 micrometers or more, are substantially free of pores on their surface. Preferably, in the powder coating composition according to the present invention, the selection of a combination of a first polyester resin having a specific glass transition temperature and a second polyester resin having a specific melt viscosity as a polyester resin is particularly advantageous for further improving low-temperature curing properties of the powder coating compositions formulated therefrom, as well as coating properties of the resulting coatings.

It was surprisingly found by the inventors of the present invention that the combination of triglycidyl isocyanurate (TGIC) and β-hydroxyalkyl amide (HAA) as a curing agent in the formulation of a powder coating composition not only facilitates realization of a low-temperature curing performance and reduction of the amount of a curing accelerant, but also significantly improves storage stability of the resultant powder coating composition, which could not have been foreseen prior to the present application. Furthermore, it was surprisingly found by the inventors of the present invention that additional addition of a weather-resistant polyester containing 5% active polyester component as a curing accelerator, in the formulation of the powder coating composition not only reduces curing temperature and increases curing speed of the resulting powder coating composition, but also does not adversely affect weathering resistance of the resulting coating as conventional curing accelerators do. On the contrary, it improves leveling and weathering resistance of the resulting coating.

The details of one or more embodiments of the invention are set forth in the description below. Other features, objects, and advantages of the invention will be apparent from the description, and from the claims.

### Definition

As used herein, “a”, “an”, “the”, “at least one”, and “one or more” are used interchangeably. Thus, for example, a coating composition that comprises “an” additive can be interpreted to mean that the coating composition includes “one or more” additives.

Throughout the present application, where compositions are described as having, including, or comprising specific components or fractions, or where processes are described as having, including, or comprising specific process steps, it is contemplated that the compositions or processes as disclosed herein may further comprise other components or fractions or steps, whether or not, specifically mentioned in this invention, as along as such components or steps do not affect the basic and novel characteristics of the invention, but it is also contemplated that the compositions or processes may consist essentially of, or consist of, the recited components or steps.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

As used in the connection of “first polyester resins and second polyester resins”, the term “glass transition temperature (Tg)” refers to measured Tg of the corresponding resin. According to the present invention, the glass transition temperature of said polyester resins is measured by means of DSC differential scanning calorimetry (DSC) according to ISO 11357.

As used in the connection of “first polyester resins and second polyester resins”, the term “acid value” (AV) refers to measured AV of the respective resin. According to the present application, the acid value (AV) in mg KOH/g resin of side polyester resins is measured by titration according to ISO 2114-2000. The acid value of polyester resins is a measure of the amount of carboxylic acid groups in the polyester resins.

In the context of the present application, the term “viscosity” or equivalently “melt viscosity” denotes a melt viscosity of the melt at 200° C. in mPa·s, as measured at 200° C. on a Brookfield CAP 2000+H Viscometer. The applied shear rate is 21 s⁻¹ and a 19.05 μmm spindle is used, i.e. a conical spindle CAP-S-05 (19.05 μmm, 1.8°).

In the context of the present invention, the term “polyester resin” denotes polyester resins having mainly carboxylic acid functional groups but not excluding hydroxyl functional groups, thus known as a carboxylic acid-functional polyester resin, in which the acid value of the carboxylic acid-functional polyester resin is significantly higher than its hydroxyl value.

As used in the connection of “cure accelerators”, the term “active polyester” refers to polyester resins capable of reacting physically and/or chemically with components contained in the coating composition, in particular the curing agent, including but not limited to polyester resins capable of performing physical entanglement, chemically crosslinking.

In the context of the present invention, the term “composition” denotes: a combination and/or mixture of different chemical substances and/or components, which form a whole.

In the context of the present invention, the term “powder” denotes: a solid substance which is substantially dry at room temperature and atmospheric pressure, and which is reduced to a state of fine, loose particles, wherein individual particles at 23° C. and atmospheric pressure have a maximum particle size of preferably up to 200 μm, more preferably up to 180 μm, even more preferably up to 160 μm, most preferably up to 150 μm, especially up to 140 μm, more especially up to 130 μm, most especially up to 120 μm, e.g. up to 110 μm, e.g. up to 100 μm, e.g. up to 90 μm; and wherein the individual particles at 23° C. and atmospheric pressure have a minimum particle size of preferably at least 10 μm, more preferably at least 15 μm, even more preferably at least 20 μm, most preferably at least 25 μm, especially at least 30 μm, more especially at least 35 μm, most especially at least 40 am, for example at least 45 μm, for example at least 50 μm, for example at least 60 μm, for example at least 70 μm. A particle is defined as a small object that: a) has an average linear size as described herein and b) behaves as a single unit in terms of its transportation and performance. The method used to measure the particle size of the powder coating compositions of the present invention is sieve analysis.

In the context of the present invention, the term “curing” denotes a process of becoming “fixed” to form an irreversible crosslinked network (so-called “cured forms” or “cured compositions”) in which the material no longer flows, melts or dissolves. As used herein, the terms “curing” and “crosslinking” are used interchangeably.

In the context of the present invention, the term “powder coating” denotes a cured powder coating composition in the form of a coating. The powder coating is obtained upon curing the powder coating composition.

As used in connection with “coatings formed from powder coating compositions”, the phrase “substantially free of pores” means that the surface of said coatings is smooth, e.g. when viewed with the naked eye, preferably with an optical microscope at 20×, 20× or even 50×, no pinholes can be detected.

Unless the context clearly indicates otherwise, the plural form of terms such as those used herein (e.g. polyester resins, curing agents, powder coating compositions, components) may be interpreted as comprising the singular form of the terms and vice versa.

In the present invention, the range of values defined by endpoints includes all values within that range, e.g., range from 1 to 5 covers values 1, 1.5, 2, 2.75, 3, 3.80, 4, 5, and the like. Further, the disclosed range of values includes all subset ranges within that wider range, e.g., range of 1 through 5 includes sub-ranges 1 through 4, 1.5 through 4.5, 1 through 2, and the like.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

### DETAILED DESCRIPTION

The present embodiments of the present application in one aspect provides a powder coating composition comprising a polyester resin, a triglycidyl isocyanurate (TGIC) curing agent, a β-hydroxyalkylamide (HAA) curing agent and a leveling agent, wherein the leveling agent is a polymeric material in solid form with a melting point below 100° C. and a melt viscosity below 2000 μmPa·s, as measured using a Brookfield viscometer at 200° C.

Under the national policy of energy conservation and emission reduction, low-temperature curing powder coating compositions are receiving more and more attention, and are expected to be the preferred products in the powder coating industry in the future. At present, on the market, low temperature curing powder coating products are generally immature and there is huge room for progress. To this end, the present invention provides a novel low temperature curing powder coating composition. In the powder coating composition according to embodiments of the present invention, a polyester resin is used as a base material, a combination of both triglycidyl isocyanurate (TGIC) and β-hydroxyalkyl amide (HAA) is used as a curing agent, and a leveling agent having specific melting properties is additional added, so that the resulting powder coating composition is suitable for low-temperature (e.g., at 140° C. or lower) curing and may address the problem of pinholes appearing on the surface of coatings especially thickly applied coatings caused by use of the HAA curing agent, and thus the coating formed from such a powder coating composition, is essentially free of holes pores on its surface, even with a thickness of up to 120 μmicrometers or more, for example 200 μmicrometers.

In embodiments according to the present invention, the polyester resin which is a base material may be a linear or branched polyester resin. Preferably, the polyester resin is a linear polyester resin having an average functionality of about 2, for example formed by polycondensation of a dibasic carboxylic acid and a diol. The polyester resin having a linear structure is advantageous for formulating powder coating compositions having good leveling properties.

In embodiments according to the present invention, the polyester resin is suitable for TGIC curing and/or HAA curing, and therefore it may also be referred to as a carboxylic acid functionalized polyester resin. In the present invention, an acid value of the polyester resin is an important parameter for both leveling performance and low-temperature curing properties of the TGIC-cured and/or HAA-cured powder coatings formulated therefrom. Therefore, the acid value of the polyester resin according to the present invention is selected in the range of 32-38 mg KOH/g resin, preferably in the range of 32-36 mg KOH/g resin.

In some embodiments according to the present invention, said polyester resin may have, in addition to the carboxylic acid functional groups, an amount of hydroxyl value. Considering that the polyester resin of the present invention is cured using TGIC curing and/or HAA curing, however, the hydroxyl value (OHV) does not exceed 10 mg KOH/g resin, preferably having a hydroxyl value in the range of up to 8 mg KOH/g resin, even more preferably up to 6 mg KOH/g resin, even more preferably up to 4 mg KOH/g resin, most preferably up to 3 mg KOH/g resin.

In some embodiments according to the present invention, the polyester resin may have a glass transition temperature (Tg) within a specific range. Said glass transition temperature may be measured by differential scanning calorimetry (DSC) according to ISO 11357 at a heating rate of 5° C./min. It is surprisingly found by the inventors of the present invention that the presence of a polyester resin having a specific glass transition temperature in a powder coating composition can significantly improve low-temperature curing properties of the coating, such that the powder coating composition formulated therefrom can be cured at temperatures as low as 140° C. Preferably, said polyester resin has a glass transition temperature of as low as 60° C., preferably having a glass transition temperature of 55-58° C.

In some embodiments according to the present invention, the polyester resin may have a specific melt viscosity, as determined at 200° C. using a Brookfield viscometer. It was surprisingly found by the inventors of the present invention that the presence of a polyester resin having a specific melt viscosity in a powder coating composition may significantly improve leveling properties of the coating, resulting in a higher gloss of the resulting coating. Preferably, said polyester resin has a melt viscosity as low as 3000 μmPa·s, preferably having a melt viscosity in the range of 2000 μmPa·s to 2500 μmPa·s.

It was surprisingly found by the inventors of the present invention that in the formulation of the powder coating composition according to the present invention, low-temperature curing properties and film-forming properties of the powder coating composition can be further adjusted by adjusting the combination of polyester resins. Thus, in some preferred embodiments according to the present invention, said polyester resin may be a combination of a first polyester resin and a second polyester resin. Preferably, said first polyester resin may have a glass transition temperature of less than 60° C., preferably with a glass transition temperature in the range of 55-58° C. Optionally, said first polyester resin may have a melt viscosity in the range of 5000 μmPa·s to 35000 μmPa·s, said melt viscosity being determined at 200° C. using a Brookfield melt viscometer. Preferably, said second polyester resin may have a melt viscosity as low as 3000 μmPa·s, preferably having a melt viscosity in the range of 1500 μmPa·s to 2500 μmPa·s, said melt viscosity being determined using a Brookfield melt viscometer at 200° C. Optionally, said second polyester resin may have a glass transition temperature of below 65° C., preferably in the range of 55 to 63° C. In some embodiments according to the present invention, both said first polyester resin and said second polyester resin have an acid value in the range of 32-38 mg KOH/g resin.

It was surprisingly found by the inventors of the present invention that the selection of a combination of a first polyester resin having a specific glass transition temperature as described above and a second polyester resin having a specific melt viscosity as described above as a polyester resin in the powder coating composition according to the present invention is particularly advantageous for further improving low-temperature curing properties of the powder coating compositions formulated therefrom, as well as coating properties of the resulting coatings.

In a preferred embodiment according to the present invention, said powder coating composition comprises, based on the total weight of said powder coating composition, at least 80 wt % of the polyester resin. Preferably, said polyester resin is present in an amount in the range of 80 wt % to 90 wt % by weight relative to the weight of said powder coating composition, more preferably, said polyester resin is present in an amount in the range of 85 wt % to 90 wt % by weight relative to the weight of said powder coating composition. Preferably, in embodiments where the polyester resin is a combination of a first polyester resin and a second resin, a weight ratio of said first polyester resin to said second polyester resin is in the range of from 1:2 to 2:1, preferably in the range of from 1:1.5 to 1.5:1, more preferably in the range of from 1:1.3 to 1.3:1.

By way of exemplary illustration, said polyester resin may be commercially available or may be prepared as desired. In some embodiments according to the present invention, said polyester resin may be Kinte NH-9362 commercially purchased from DynaSky, or Allnex 4430 commercially purchased from Allnex.

In embodiments according to the present invention, a combination of both triglycidyl isocyanurate (TGIC) and β-hydroxyalkyl amide (HAA) is used as a curing agent in the formulation of the powder coating composition. As described herein, “curing agent” refers to a compound which can be used as a crosslinking agent for an acid-functionalized or carboxyl-capped polyester resin. Typically, this type of curing or cross-linking agent may include, for example, epoxy-functionalized compounds, amides, substituted alkyl amides, bis-amides, and the like. However, in the formulation of the powder coating composition according to the present invention, the curing agent is specifically a combination of TGIC and HAA, TGIC being a triazine compound with reactive epoxy functional groups, which is considered in the art to be a preferred curing agent for acid-functionalized resins (e.g., acrylics, polyester resins, etc.) and HAA being a compound having four active hydroxyl groups in its molecular structure, which undergoes a dehydration polycondensation reaction with carboxyl groups. It was surprisingly found by the inventors of the present invention that the use of a combination of triglycidyl isocyanurate (TGIC) and β-hydroxyalkyl amide (HAA) as a curing agent in the formulation of the powder coating composition according to the present invention not only facilitates realization of low-temperature curing properties and reduction in the amount of curing accelerators, but also significantly improves storage stability of the resultant powder coating composition. For example, said powder coating composition can be stored at a temperature of 40° C. for 20 days or more or at a temperature of 30° C. for 6 μmonths or even at a temperature of 24° C. for 6-12 μmonths without any agglomeration and/or cross-linking.

In a preferred embodiment according to the present invention, said powder coating composition comprises, based on the total weight of said powder coating composition, 5 to 8 wt. %, preferably 6-8 wt. % of a TGIC curing agent and 1-3 wt. %, preferably 1.5-3 wt. % of a HAA curing agent.

It is well known that in the formulation of polyester-type powder coating compositions, the HAA-type curing agent has the advantages of low dosage, low curing temperature, and non-toxicity, but it also inevitably bring about the problem of pinholes appearing on the surface of coatings due to its high volatility. It is surprisingly found by the inventors of the present application that the problem of pinholes on the surface of the resulting coating film, especially with a high thickness, caused by the use of the HAA curing agent may be solved by the formulation of a powder coating composition using a polyester resin as a base material, a combination of triglycidyl isocyanurate (TGIC) and β-hydroxyalkyl amide (HAA) as a curing agent, and additionally adding a leveling agent having specific melting properties, so that the coating formed from such powder coating composition, even with a thickness of up to 120 μmicrometers or more (e.g., 200 micrometers), is substantially free of pores on its surfaces. In embodiments according to the present invention, said leveling agent is a polymeric material in solid form having a melting point below 100° C. and having a melt viscosity below 2000 μmPa·s. In some embodiments according to the present invention, said leveling agent has a melting point in the range of 40 to 100° C. In other embodiments according to the present invention, said leveling agent has a melt viscosity in the range of 800 to 2000 μmPa·s, said melt viscosity being determined at 200° C. using a Brookfield viscometer.

Not being subjected to any theory, the inventors hypothesize that a leveling agent having the specific melt properties described above has a low melting point, a low melt viscosity, good flowability, and is capable of delaying the curing process; and that it is capable of providing good wettability and releasing air, and that the leveling agent acts as a bridge between pigments and resins, anchoring the pigments at one end and being compatible with the resins at the other end, and reduces the difference in surface tension between the pigments and the resins. As a result, during the curing process of the powder coating composition, small molecules produced by reaction have enough time to float away, allowing pinhole defects on the surface of the coating to be restored.

In the coating composition according to the present invention, any leveling agent known from powder coating compositions having the above-described melting properties may be used. By way of illustration, said leveling agent is one or more selected from polyacrylates, silicone-modified polyacrylates, polysiloxanes, hydrogenated castor oil, and polyvinyl butyral, preferably from polyacrylates, silicone-modified polyacrylates, and polysiloxanes, more preferably from polyacrylates.

In a preferred embodiment according to the present invention, said powder coating composition comprises, based on the total weight of said powder coating composition, from 0.1 to 2 wt %, preferably from 0.5 to 1.5 wt %, of a leveling agent.

As an exemplary illustration, said leveling agent may be commercially available or may be prepared as needed. In some embodiments according to the present invention, said leveling agent may be Resinflow PL-200 commercially available from Estron Chemical.

In an embodiment according to the present invention, the powder coating composition according to the present invention further comprises a weather-resistant polyester containing 5% active polyester component as a curing accelerator. As the name suggests, a curing accelerator is an additive that promotes curing of the powder coating composition, which preferably contributes to enabling the powder coating composition to obtain a low curing temperature. The mainstream curing accelerators currently available in the market for use in powder coating compositions are usually low molecular compounds, which additives, although capable of improving curing performances of the coating, would inevitably affect weatherability of the coating. It was surprisingly found by the inventors of the present invention that the additional addition of a weathering-resistant polyester containing 5% active polyester component as a curing accelerator in the formulation of the powder coating composition not only reduces curing temperature and increases curing speed of the resulting powder coating composition, but also does not adversely affect weathering resistance of the resulting coating as conventional curing accelerators do. On the contrary, it can improve leveling properties and weathering resistance of the coating. For example, in some embodiments according to the present invention, a powder coating composition comprising the curing accelerator described above can be cured at a temperature of 130° C. or lower and show good coating weathering properties.

In a preferred embodiment according to the present invention, said powder coating composition comprises, based on the total weight of said powder coating composition, 0.5 wt % or less, preferably 0.1 wt % or less, of a curing accelerator. In some embodiments according to the present invention, said powder coating composition is substantially free of any curing accelerator, preferably free of any curing accelerator.

As an exemplary illustration, said cure accelerators may be commercially available or may be prepared as needed. In some embodiments according to the present invention, said curing accelerator may be a product with the grade number ADDITOL P966.

In embodiments according to the present invention, additional additives may optionally be included in the powder coating composition according to the present invention, which do not adversely affect the powder coating composition or the cured coating obtained therefrom. Suitable additives include, for example, those that will improve the processability or manufacturability of the composition, those that will improve specific functional properties or characteristics (such as adhesion to the substrate) of the coating compositions or the cured coatings obtained therefrom, or those that will reduce the cost. Examples of additives suitable for use in powder coating compositions include colorants, inorganic fillers, surfactants, flow control agents, heat stabilizers, preservatives, antioxidants, tackifiers, light stabilizers, leveling agents, defoamers, and combinations thereof. For example, the powder coating composition may comprise a colorant, such as a pigment or dye. The amount of each optional ingredient is sufficient to serve its intended purpose, but preferably such an amount does not adversely affect the powder coating composition or the cured coating obtained therefrom. The total amount of additional additives according to the present invention is from 0 wt. % to about 5 wt. %, preferably from 0.1 to 5 wt. %, relative to the total weight of the powder coating composition.

In a preferred embodiment according to the present invention, said powder coating composition comprises, based on the total weight of said powder coating composition,
at least 80 wt % of said polyester resin.
5 to 8 wt % of said TGIC curing agent,
1 to 3 wt % of said HAA curing agent,
0.1 to 2 wt. % of said leveling agent,
0 to 0.5 wt % of said curing accelerator, and
0 to 5 wt % of said additional additions, said additional additions being one or more selected from benzoin, wetting agents, defoamers, and pigments.

In addition, the present invention provides a method for preparing a powder coating composition comprising the steps:
a) Pre-mixing and pulverizing in a pre-mixer all polyester resins according to the present invention, TGIC curing agents, HAA curing agents, leveling agents and optionally additives for the manufacture of the powder coating;
b) melt extruding through an extruder the pre-mixed and pulverized raw materials;
c) cooling and pressing the melt extruded materials into flakes; and
d) crushing and sieving the flakes in a pulverizer to obtain powder particles of suitable particle size, i.e., powder coating composition.

The resulting powder particles are sprayed onto a suitable substrate using an electrostatic spray gun and placed in an oven at a certain temperature for curing. After curing the powder coating is obtained. Said powder coating may be a primer, a topcoat or an intermediate coating. In the case of heating the powder coating composition to cure it, the heating of the powder coating composition may be carried out at a certain temperature and for a suitable period of time to cure the powder coating composition of the present invention. The heating of the powder coating composition may be carried out using conventional methods, such as with a convection oven and/or (N)IR lamps, and/or infrared laser and/or microwave devices.

In some embodiments according to the present invention, the powder coating composition according to the present invention may be cured at a temperature of 140° C. or lower, preferably at a temperature of 130° C. or lower.

In some embodiments according to the present invention, the powder coating composition according to the present invention may be cured at a temperature of 140° C. or lower without the addition of any curing accelerator.

In some embodiments according to the present invention, the coating formed by curing the powder coating composition according to the present invention is substantially free of pores on its surface.

Thus, the present invention also provides an article comprising a substrate partially or wholly coated with a powder coating composition according to the present invention or a powder coating composition obtainable by a method according to the present invention. A person of ordinary skill in the art will select and identify a suitable material as a substrate based on practical needs. Said substrate may be, for example, a substrate of glass, ceramic, wood, fiber cement board or metal (e.g. aluminum, copper or steel).

The present invention also relates to use of polyester resins, or powder coating compositions as described herein in powder coatings, in-mold powder coatings, 3D printing, motor vehicle applications (automotive parts, agricultural machinery, composite structures, ceramic structures, etc.), marine applications (ships, boats), aerospace applications (airplanes, helicopters, composite structures, ceramic structures, etc.), medical applications (artificial joints, nets, textile or non-woven sheets, tapes, ribbons, tapes, cables, tubular products such as ligament substitutes, composite structures, ceramic structures, etc.), protective applications (ballistic equipment, bulletproof vests, bulletproof undershirts, bulletproof helmets, bulletproof vehicles, composite structures, ceramic structures, etc.), sports/recreational applications (fencing, ice skating, skateboarding, snowboarding, slings in sports parachutes, paragliders, kites, kite strings for kiteboarding, mountaineering equipment, composite structures, ceramic structures, etc.), building applications (windows, doors, (false) walls, cables, etc.), bottling and filling applications, household applications (household appliances, white goods, furniture, computer housings, etc.), machine applications (machine parts for can and bottle handling, moving parts for textile machines, bearings, gears, composite structures, ceramic structures, computer housings, etc.), tank applications, coil applications, energy applications (for e.g. wind, tidal or solar power generators), textile applications (for e.g. fabrics, which can be very broad, ranging from impregnated technical textiles to e.g. full composites, both as coatings and as binders for composites) and electrical applications (cabinets for e.g. electrical wiring or switchboards).

### Test Methods

Unless otherwise noted, the following test methods are utilized in the following examples.

### Melt Viscosity

Melt viscosity was a melt viscosity in Pa·s at 200° C. according to ISO 3219. The Viscosity was measured at 200° C. on a Brookfield CAP 2000+H Viscometer. The applied shear rate was 21 s⁻¹ and a 19.05 μmm spindle was used, i.e. conical spindle CAP-S-05 (19.05 mm, 1.8°).

### Gloss

This test was used to measure gloss of the cured coating. A gloss meter according to ISO 2813 was used to evaluate the gloss at 20° and 60°.

### Impact Resistance

Impact resistance was a degree of deformation of a coating under a high speed loading. Impact resistance was assessed using an impact tester according to GB/T1732-93.

### WEATHERING Resistance

Weathering resistance was measured by subjecting the resulting coating film to a xenon lamp test at 3350 hours.

### Storage Stability

This test was used to measure stability of powder coating compositions during storage. Storage stability was assessed according to ISO 8130-8.

### Examples

The following examples describe the present application in more detail, which are for illustrative purposes only, since various modifications and changes will be apparent to those skilled in the art from the scope of the present application. Unless otherwise indicated, all parts, percentages, and ratios reported in the following examples are on a weight basis and all reagents used in the examples are commercially available and may be used without further treatment.

### Raw Materials:

A first polyester resin: polyester resin with a glass transition temperature below 60° C., commercially available from Kinte NH-9362 from DynaSky;
A second polyester resin: polyester resin with a viscosity of less than 3000 μmPa·s, commercially purchased from Allnex, Allnex 4430;
TGIC: general industrial product;
HAA: general industrial product;
Leveling agent: Resinflow PL-200, commercially available from Estron Chemical;
Curing accelerator: ADDITOL P966 from Allnex;
Additional additives: conventional industrial products.
   Composition of Powder Coating Compositions and their Properties

The powder coating compositions were prepared according to the dosages in Table 1 below and sprayed onto degreased, iron-phosphate treated steel slats using an electrostatic spray gun, and then baked and cured in an oven. The properties of the powder coating can be tested after curing.

TABLE 1

| | | | | | Comparative | Comparative |
|---|---|---|---|---|---|---|
| Components | Unit | Example 1 | Example 2 | Example 3 | Example 1 | Example 2 |
| First resin | g | 88.8 | 49.3 | 49.3 | 88.8 | 88.8 |
| Second resin | g | — | 39.5 | 39.5 | — | — |
| TGIC | g | 5.7 | 5.0 | 5.0 | 6.7 | 5.0 |
| HAA | g | 1.0 | 2.0 | 2.0 | — | 2.0 |
| Leveling agent | g | 1.0 | 1.0 | 1.0 | — | — |
| Curing | g | — | — | 0.5 | — | — |
| accelerator | | | | | | |
| Additional | g | 3.5 | 3.2 | 2.7 | 4.5 | 4.2 |
| additives | | | | | | |
| Total | g | 100 | 100 | 100 | 100 | 100 |

| | | | | | |
|---|---|---|---|---|---|
| Curing properties | 140° C./30 min | 140° C./30 min | 130° C./30 min | 160° C./15 min | 140° C./30 min |
| Gloss/(20/60°) | Flat and smooth | Flat and smooth | Flat and smooth | Flat and smooth | Obvious pinholes |
| | coating film | coating film | coating film | coating film | in the coating film |
| | 80+/90+ | 80+/90+ | 80+/90+ | 80+/90+ | 50-60/70-80 |
| Impact resistance | Positive punch: | Positive punch: | Positive punch: | Positive punch: | Positive punch: |
| | 40-50 kg · cm | 40-50 kg · cm | 40-50 kg · cm | 40-50 kg · cm | 40-50 kg · cm |
| Weathering resistance | Light retention | Light retention | Light retention | Light retention | Light retention |
| | rate: 95.5%. | rate: 96.5% | rate: 95.0%. | rate: 96.0%. | rate: 93.0%. |
| | Slight | Slight | Slight | Slight | Slight |
| | discoloration of | discoloration of | discoloration of | discoloration of | discoloration of |
| | coating film | coating film | coating film | coating film | coating film |
| Storage stability | 40° C. 21 d | 40° C. 28 d | 40° C. 28 d | 40° C. 7 d | 40° C. 28 d |

As can be seen from the results in Table 1 above, in the powder coating composition according to the present invention, by using the polyester resin as a base material, a combination of both triglycidyl isocyanurate (TGIC) and β-hydroxyalkyl amide (HAA) as a curing agent, and by combining the same with a leveling agent having a specific melting property, it is possible to form a powder coating composition which is suitable for low-temperature (e.g., at 140° C. or lower) and to solve the problem of pinholes appearing on the surface of the coatings, especially having a thickness of up to 120 μmicrometers or more (e.g., 200 μmicrometers), caused by the use of the HAA curing agent. Furthermore, as can be seen from Example 2, the selection of a combination of the first polyester resin having a specific glass transition temperature and the second polyester resin having a specific melt viscosity as the polyester resin is particularly advantageous for further improving low-temperature curing properties of the powder coating composition formulated therefrom, as well as the coating properties of the resulting coating. Furthermore, as can be seen from Example 3, the additional addition of a curing accelerator to the above-described powder coating composition significantly reduces curing temperature and maintains good weathering properties.

In contrast, the curing temperature of the powder coating composition employing a TGIC curing agent alone in Comparative Example 1 is significantly higher than that of the powder coating composition according to the present invention; and although the powder coating composition employing the combination of both TGIC and HAA as a curing agent in Comparative Example 2 has a reduced curing temperature, the coating film is characterized by pinholes on its surface and a significant decrease in the gloss level.

While the invention has been described with respect to a number of embodiments and examples, those skilled in the art, having benefit of this invention, will appreciate that other embodiments can be devised which do not depart from the scope and spirit of the invention as disclosed herein.

What is claimed is:

1. A powder coating composition comprising a polyester resin, a triglycidyl isocyanurate (TGIC) curing agent, a β-hydroxyalkylamide (HAA) curing agent and a leveling agent, wherein the leveling agent is a polymeric material in solid form with a melting point below 100° C. and a melt viscosity below 2000 μmPa s, as measured using a Brookfield viscometer at 200° C.

2. The powder coating composition of claim 1, wherein the leveling agent has a melting point in the range of 40 to 100° C.

3. The powder coating composition as claimed in claim 1, wherein the leveling agent has a melt viscosity in the range of 800 to 2000 μmPa s, as measured using a Brookfield viscometer at 200° C.

4. The powder coating composition claim 1, wherein the leveling agent is one or more selected from polyacrylates, silicone-modified polyacrylates, polysiloxanes, hydrogenated castor oil, and polyvinyl butyral, preferably one or more selected from polyacrylates, silicone-modified polyacrylates, and polysiloxane, more preferably polyacrylates.

5. The powder coating composition claim 1, wherein the polyester resin comprises a mixture of a first polyester resin and a second polyester resin, the first polyester resin having a glass transition temperature below 60° C., the second polyester resin having a melt viscosity as low as 3000 μmPa s as measured using a Brookfield viscometer at 200° C.

6. The powder coating composition of claim 5, wherein the first polyester resin has a glass transition temperature in the range of 55-58° C. and the second polyester resin has a melt viscosity in the range of 1500 μmPa s to 2500 μmPa s, as measured using a Brookfield viscometer at 200° C.

7. The powder coating composition of claim 5, wherein the first polyester resin has a melt viscosity in the range of 5000 μmPa s to 35000 μmPa s, as measured using a Brookfield viscometer at 200° C.

8. The powder coating composition of claim 5, wherein the second polyester resin has a glass transition temperature of no higher than 65° C., preferably in the range of 55 to 63° C.

9. The powder coating composition of claim 5, wherein the first polyester resin and the second polyester resin both have an acid number in the range of 32-38 mg KOH/g resin.

10. The powder coating composition of claim 1, further comprising a weather-resistant polyester containing 5% active polyester component as a curing accelerator, which is present in an amount of 0.5 wt % or less, relative to the total weight of the powder coating composition.

11. The powder coating composition of claim 1, wherein the powder coating composition is substantially free of any curing accelerator.

12. The powder coating composition of claim 1, wherein the powder coating composition comprises, relative to the total weight of the powder coating composition,
at least 80% by weight of the polyester resin,
5 to 8% by weight of the TGIC curing agent,
1 to 3% by weight of the HAA curing agent,
0.1 to 2% by weight of the leveling agent,
0 to 0.5% by weight of a curing accelerator, and
0 to 5% by weight of additional additives.

13. The powder coating composition of claim 1, wherein the powder coating composition is cured at a temperature of 140° C. or lower, preferably at a temperature of 130° C. or lower.

14. The powder coating composition of claim 1, wherein the powder coating composition is cured at a temperature of 140° C. or lower without the addition of any curing accelerator.

15. The powder coating composition of claim 1, wherein the coating formed by curing the powder coating composition is substantially free of pores.

16. An article comprising
a substrate; and
a coating formed from the powder coating composition of claim 1 applied directly to the substrate.

17. The article of claim 16, wherein the substrate comprises a metal substrate, a wood substrate, a plastic substrate, a glass substrate, a ceramic substrate, or a combination thereof.
